(19) United States
(12) Patent Application Publication
(10) Pub. No.: US 2007/0092350 A1
(43) Pub. Date: Apr. 26, 2007

(54) Self-rising lock-off arm

(75) Inventor: Howard Schorer, Grosse Pointe Woods, MI (US)

Correspondence Address: HARNESS, DICKEY & PIERCE, P.L.C., P.O. BOX 828, BLOOMFIELD HILLS, MI, 48303, US

(73) Assignee: Repair Industries of Michigan, Inc., Detroit, MI (US)

(21) Appl. No.: 11/586,110

(22) Filed: Oct. 25, 2006

Related U.S. Application Data
(60) Provisional application No. 60/730,110, filed on Oct. 25, 2005.

(51) Int. Cl. B60P 7/06; A47F 5/00

(52) U.S. Cl. 410/43; 211/183

(57) ABSTRACT

A self-rising lock-off arm assembly for a packaging system has a release lever which releases a movable arm. A biasing member moves the movable arm to its open or unlocked position from its closed or locked position when the release lever is actuated. the self-rising lock-off arm assembly can be moved back to its closed or locked position from its open or unlocked position by applying a force to the movable arm. The moving of the self-rising lock-off arm assembly to its closed or locked position preloads the biasing member.

### CROSS-REFERENCE TO RELATED APPLICATIONS

This application claims the benefit of U.S. Provisional Application No. 60/730,110, filed on Oct. 25, 2005.

### FIELD

The present disclosure is directed to a lock-off arm for dunnage. More particularly, the present invention is directed to a self-rising lock-off arm which is compatible with manual and robotic loading and unloading mechanisms.

### BACKGROUND

The statements in this section merely provide background information related to the present disclosure and may not constitute prior art.

Automotive components, typically stamped steel components, are shipped from the component manufacturer to the assembly facility using large racks, frames or dunnage. These racks, frames or dunnage typically contain a multiple number of components and they are designed to nest or locate the individual components for shipment. One or more dunnage bars are utilized to lock these components within the racks, frames or dunnage during shipment. The components are positioned within the racks, frames or dunnage and then the dunnage bars are positioned to prevent removal of the components. Once at the assembly facility, these dunnage bars are removed or repositioned to allow for the removal of the components.

Various prior art devices have been developed which aid in the attachment and removal or repositioning of the dunnage bars. Some prior art designs require manipulation of a latch at each end of the dunnage bar before the dunnage bar can be removed. Other prior art designs allow the positioning and removal or repositioning of the dunnage bar by manipulation of a device located at only one end of the dunnage bar. Still other prior art devices have dunnage bars that are not removable from the racks, frames or dunnage. These attached dunnage bars are movable between an open position where the components can be added or removed from the racks, frames or dunnage and a closed position where the components are prevented from being removed from the racks, frames or dunnage.

As assembly processes become more and more automated, the loading and unloading of the components into and out of the racks, frames or dunnage are being done using robotics. While the prior art dunnage bars can be manipulated by the robotics, the movements required to move the dunnage bars between their open and closed positions can be complicated and difficult to program into the robotic system. The continued development of dunnage bars includes development of systems which simplify the opening and closing of the dunnage bars to simplify the task of programming the robotic systems that are used for loading and unloading the components.

### SUMMARY

The present disclosure provides a dunnage bar which is self-rising or self-opening once a release lever is actuated. A biasing member moves the dunnage bar from its closed position to its open position once the release lever is actuated. In addition, a simple movement moves the dunnage bar from its open position to its closed position. The biasing member is energized during the movement of the dunnage bar from its open position to its closed position.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a packaging system which includes the self-rising lock-off arm in accordance with the present invention;

FIG. 2 is a perspective view of the self-rising lock-off arm illustrated in FIG. 1;

FIG. 3 is a side view of the self-rising lock-off arm in its closed or locked position;

FIG. 4 is a side view of the self-rising lock-off arm in its open or unlocked position;

FIG. 5 is an enlarged side view of the release lever in the closed or locked position illustrated in FIG. 3;

FIG. 6 is an enlarged side view of the release lever in the open or unlocked position illustrated in FIG. 4; and,

FIG. 7 is an enlarged end view of the release lever in the closed or locked position illustrated in FIG. 3.

### DETAILED DESCRIPTION

The following description is merely exemplary in nature and is not intended to limit the present disclosure, application, or uses.

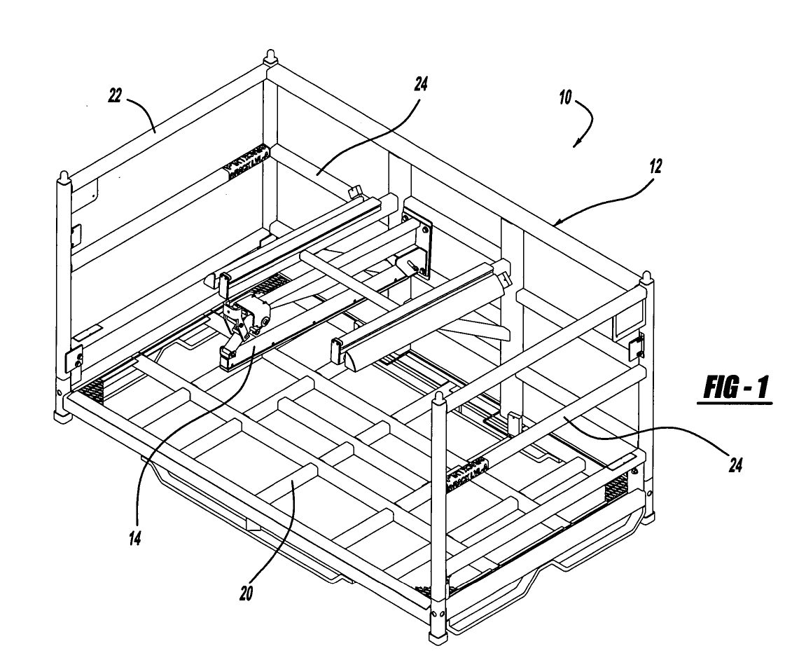

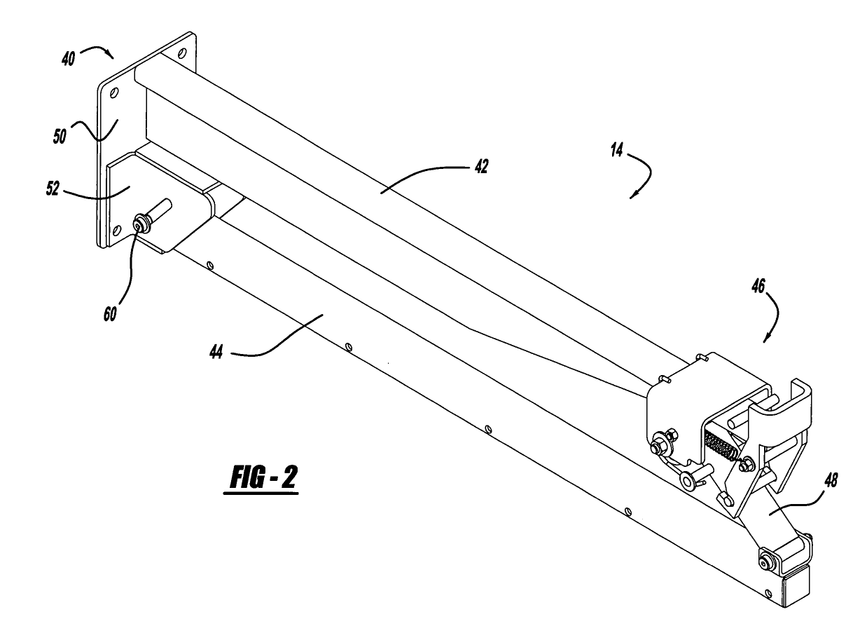

There is shown in FIG. 1 a packaging system in accordance with the present invention which is designated generally by the reference numeral 10. Packaging system 10 comprises a rack, frame or dunnage 12 and a self-rising lock-off arm assembly 14.

Rack, frame or dunnage 12 is designed to hold a plurality of components. Rack, frame or dunnage 12 includes a lower section 20, an upper section 22 and side walls 24.

Self-rising lock-off arm assembly 14 includes a base 40, a stationary arm 42, a movable arm 44, a retention mechanism 46 and a linking arm 48. Base 40 is adapted to be secured to rack, frame or dunnage 12 by welding, bolting or by any other means known in the art. Base 40 includes an attachment plate 50 and a bracket 52 which is adapted to interface with movable arm 44 as detailed below. Attachment plate 50 and bracket 52 may be separate components secured to each other by welding, bolting or by any other means known in the art or attachment plate 50 and bracket 52 can be a single integral component.

Stationary arm 42 is fixedly secured to base 40 by welding or by any other means known in the art. Stationary arm 42 extends generally perpendicular to base 40. The end of stationary arm 42 opposite to base 40 interfaces with retention mechanism 46 and linking arm 48 as detailed below.

Movable arm 44 is pivotably and movably attached to bracket 52 of base 40 by an attachment pin 60. Attachment pin 60 allows both pivotable movement of movable arm 44 around the axis of attachment pin 60 as well as translational movement within bracket 52. Bracket 52 defines a slot 62 within which attachment pin 60 is located. Attachment pin 60 moves linearly within slot 62 when movable arm 44 moves between its open and closed positions as detailed below.

Retention mechanism 46 includes a bracket 64, a release lever 66, a pair of actuation biasing member 68 and a release lever biasing member 70. Bracket 64 is fixedly secured to the end of stationary arm 42 by welding or by any other means known in the art. Release lever 66 is pivotably attached to the end of stationary arm 42 using an attachment pin 72. Attachment pin 72 is fixedly secured to stationary arm 42 by welding or by any other means known in the art. Release lever 66 is pivotably secured to attachment pin 72. While attachment pin 72 and release lever 66 are illustrated as being attached to the end of stationary arm 42, it is within the scope of the present invention to have attachment pin 72 and release lever 66 attached to bracket 64.

Linking arm 48 extends between bracket 64 and movable arm 44. Linking arm 48 is pivotably attached to bracket 64 using an attachment pin 74. Linking arm 48 is pivotably attached to movable arm 44 using an attachment pin 76. Actuation biasing members 68 are located on opposing sides of bracket 64. As illustrated in the figures, actuation biasing members 68 depicted as torsional springs which react against bracket 64 and against a reaction pin 78 fixedly attached to linking arm 48 by welding or by any other means known in the art. Actuation biasing members 68 bias linking arm 48 and thus movable arm 44 in an upward direction as illustrated in the figures. This biases movable arm 44 towards stationary arm 42.

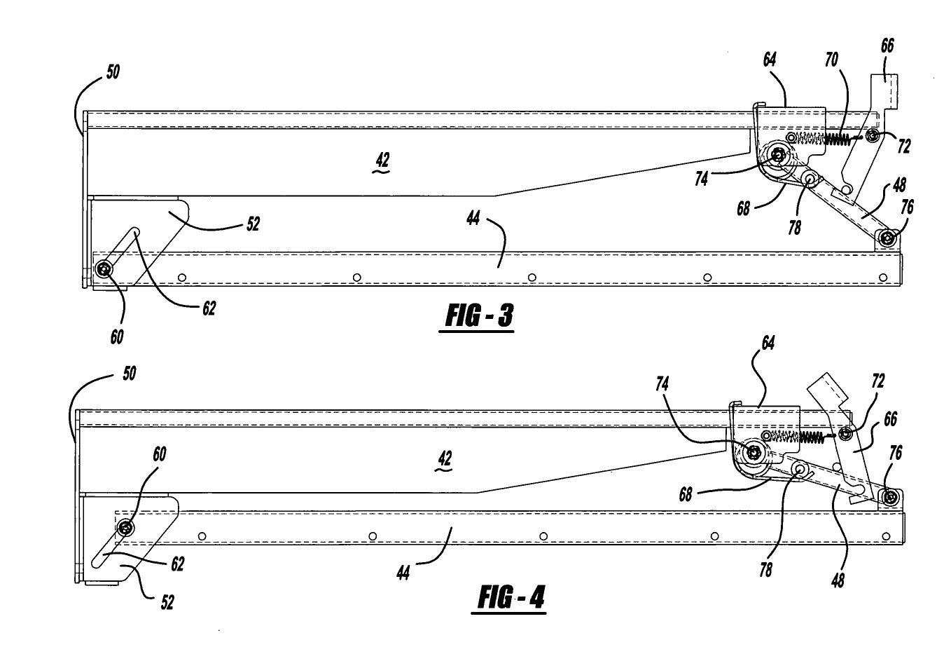

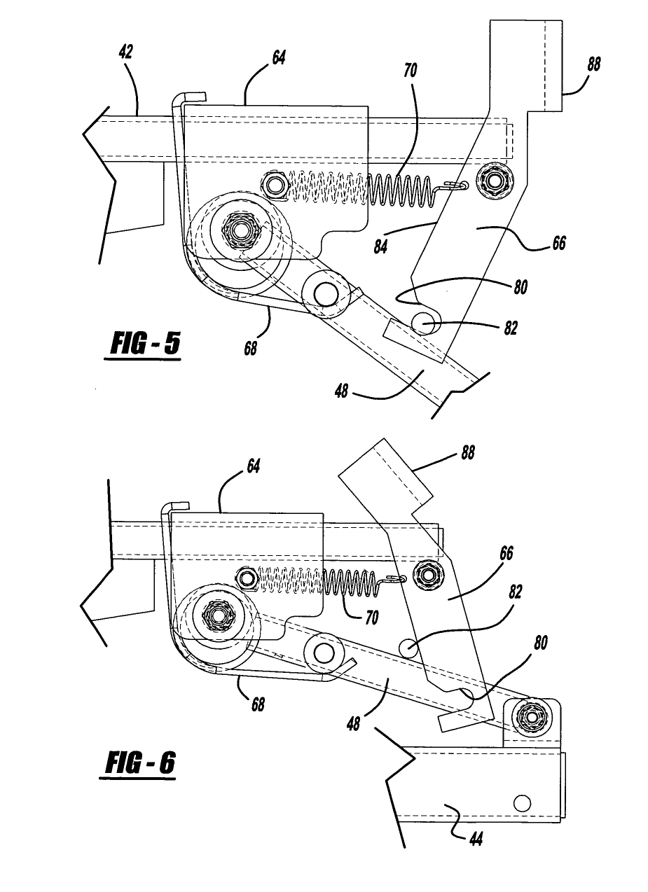

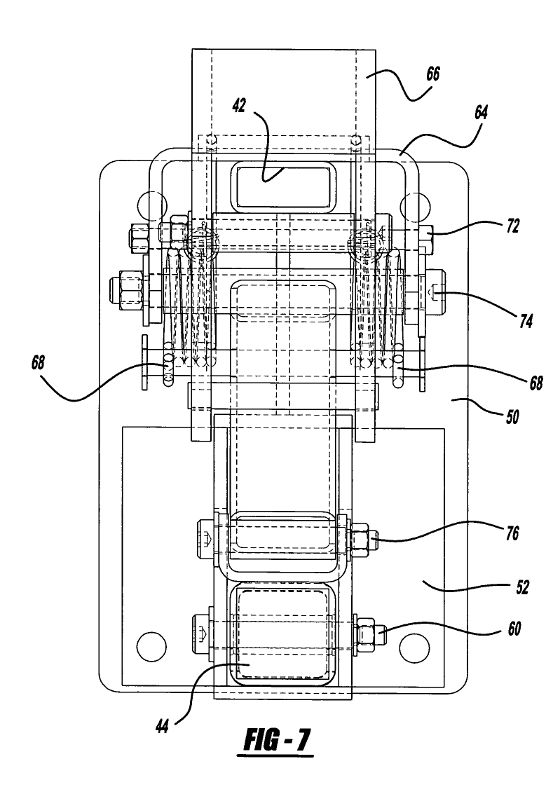

Release lever 66 defines a slot 80 which engages a release pin 82 fixedly secured to linking arm 48 by welding or by any other means known in the art. Release lever biasing member 70 extends between bracket 64 and release lever 66 to bias release lever 66 into engagement with release pin 82. When self-rising lock-off arm assembly 14 is in its closed or locked position as shown in FIG. 3, release pin 82 is disposed within slot 80 and the bottom of slot 80 is urged against release pin 82 by release lever biasing member 70. When self-rising lock-off arm assembly 14 is in its open or unlocked position as shown in FIG. 4, release pin 82 engages a pair of bearing surfaces 84 located on release lever 66 and bearing surfaces 84 are biased against release pin 82 by release lever biasing member 70.

FIG. 3 illustrates self-rising lock-off arm assembly 14 in its closed or locked position. FIG. 4 illustrates self-rising lock-off arm assembly 14 in its open or unlocked position. When self-rising lock-off arm assembly 14 is in its closed or locked position as shown in FIG. 3, a force can be applied to an upper portion 88 of release lever 66. This force will pivot release lever 66 around attachment pin 72 which will then disengage slot 80 from release pin 82. With release pin 82 being disengaged from slot 80, actuation biasing members 68 will pivot linking arm 48 in an upward direction. The upward pivoting of linking arm 48 will raise the end of movable arm 44 attached to linking arm 48 while simultaneously moving the opposite end of movable arm 44 upward as attachment pin 60 moves linearly within slot 62. Actuation biasing member 68 will move self-rising lock-off arm assembly 14 to its open or unlocked position as shown in FIG. 4.

When self-rising lock-off arm assembly 14 is in its open or unlocked position as shown in FIG. 4, a force can be applied to linking arm 48 and/or movable arm 44 in a downward direction. This force will pivot linking arm 48 in a downward direction. The downward pivoting of linking arm 48 will cause release pin 82 to move along bearing surfaces 84 until release pin 82 aligns with slot 80. At this point, release lever biasing member 70 will pivot release lever 66 to position release pin 82 within slot 80 to lock self-rising lock-off arm assembly into its closed or locked position as shown in FIG. 3. The pivoting of linking arm 48 in a downward direction operates to preload actuation biasing member 68 to again cause the upward movement of linking arm 48 when release lever 66 is actuated.

Self-rising lock-off arm assembly 14 is thus easily moved between its closed or locked position and its open or unlocked position by one simple application of a single force. The simplified actuation and movement of self-rising lock-off arm assembly 14 can be easily programmed into the robotics of a loading and an unloading system.

What is claimed is:

1. A packaging system comprising:
a frame;
a movable arm attached to the frame, the movable arm being movable between a locked position and an unlocked position;
a biasing member for urging the movable arm into the unlocked position.

2. The packaging system according to claim 1, further comprising a retention mechanism for holding the movable arm in the locked position.

3. The packaging system according to claim 2, wherein the retention mechanism comprises a release lever and a release pin.

4. The packaging system according to claim 1, further comprising:
a stationary arm attached to the frame; and
a linking arm pivotably secured to the stationary arm and the linking arm.

5. The packaging system according to claim 4, wherein the biasing member is disposed between the stationary arm and the linking arm.

6. The packaging system according to claim 4, further comprising a retention mechanism for holding the movable arm in the locked position.

7. The packaging system according to claim 6, wherein the retention mechanism comprises a release lever pivotably attached to the stationary arm and a release pin attached to the linking arm.

8. The packaging system according to claim 7, wherein the biasing member is disposed between the stationary arm and the linking arm.

9. The packaging system according to claim 1, wherein the biasing member is a torsional spring.

10. A packaging system comprising:
a frame for holding a plurality of components;
a stationary arm fixedly attached to the frame;
a movable arm movably attached to the frame, the movable arm moving between a locked position spaced from the stationary arm and an unlocked position adjacent the stationary arm;
a biasing member for urging the movable arm towards the stationary arm; and
a linking arm pivotably attached to the stationary arm and the movable arm.

11. The packaging system according to claim 10, wherein the biasing member is a torsional spring.

12. The packaging system according to claim 10, further comprising a retention mechanism for holding the movable arm in the locked position.

13. The packaging system according to claim 12, wherein the retention mechanism comprises a release lever pivotably attached to the stationary arm and a release pin attached to the linking arm.

14. The packaging system according to claim 10, wherein the biasing member is disposed between the stationary arm and the linking arm.
